(19) United States
(12) Patent Application Publication
(10) Pub. No.: US 2007/0006531 A1
(43) Pub. Date: Jan. 11, 2007

(54) Method of adjusting a component relative to a frame, system for this purpose, and product comprising an adjusted component located on a frame

(75) Inventors: Waltherus Cornelis Jozef Bierhoff, Eindhoven (NL); Johannes Joseph Hubertina Barbara Schleipen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/558,085

(22) PCT Filed: May 14, 2004
(86) PCT No.: PCT/IB04/50703

§ 371 Date: Nov. 23, 2005

(30) Foreign Application Priority Data
May 27, 2003 (EP) 03101536.5

(51) Int. Cl. E05B 65/04

(52) U.S. Cl. 49/61

(57) ABSTRACT

Method and device for positioning a component (3) with respect to a frame (2), whereby at least on positioning element (12) is introduced through at least one opening (8) of the frame. One end of the positioning element is inserted into a groove (13) of the component lying on the frame, whereby the end of the positioning element is pressed against at least one wall forming a boundary of the groove for positioning the component into the desired position.

The invention relates to a method of adjusting a component relative to a frame.

The invention further relates to a system for adjusting a component located on a frame, which system comprises an adjustment element.

The invention also relates to a product comprising an adjusted component located on a frame.

A method is known from the international patent application WO 01/151500 for adjusting two components relative to one another by means of adjustment devices comprising a number of screws. The pitch of the screws must be comparatively small in order to realize a sufficiently accurate adjustment in a desired direction.

The invention has for its object to provide a method whereby a component can be accurately adjusted relative to a frame in a comparatively simple manner.

This object is achieved in the method according to the invention in that at least one adjustment element is introduced through at least one opening of the frame, such that an end of said adjustment element is positioned in a groove of the component located on the frame, and the end of the adjustment element is urged against at least a wall bounding the groove for adjusting the component into a desired position.

The pressure exerted by the adjustment element on the wall of the groove causes a compression force on the component owing to which the component is displaced relative to the frame. Since the adjustment element lies against the wall of the component, the position of the component lying against the end of the adjustment element can be unequivocally derived from the position of the adjustment element.

An embodiment of the method according to the invention is characterized in that a force is exerted on the component from a side of the component facing away from the groove, opposite the groove, whereby the component is pressed in the direction of the frame.

As a result of this, the component will remain securely pressed against the frame while the component is being adjusted relative to the frame by the adjustment element. The adjustment of the component will take place here in a direction extending parallel to the frame.

An alternative embodiment of the method according to the invention is characterized in that the component is pressed against the frame by spring force.

Such a force can be transmitted to a component in a simple manner.

A yet further embodiment of the method according to the invention is characterized in that the component, once adjusted to the desired position, is fixed to the frame.

It is safeguarded thereby that the once adjusted position is retained. The component may be fixed on the frame by means of glue.

A still further embodiment of the method according to the invention is characterized in that the adjustment element is removed from the frame after the component has been adjusted to the desired position.

The fact that the adjustment element is removed after the adjustment of the component and preferably after the fixation of the component with respect to the frame implies that the adjustment element no longer forms part of the frame provided with a component, so that the weight thereof remains comparatively limited. In addition, the adjustment element may subsequently be used for adjusting another component with respect to another frame.

A further object of the invention is to provide a system by which a component can be accurately adjusted relative to a frame in a comparatively simple manner.

This object is achieved in the system according to the invention in that the adjustment element can be positioned in an opening of the frame, such that an end of the adjustment element is located in a groove of the component, and the component can be adjusted relative to the frame by means of the force exerted by the adjustment element on at least a wall bounding the groove.

A force can be exerted on the wall of the groove by means of the adjustment element. As a result of this, the wall will be displaced together with the component in the direction in which the force is exerted. An adjustment direction or directions may be determined in this manner in dependence on the orientation of the wall or walls of the groove.

An embodiment of the system according to the invention is characterized in that a support part of the adjustment element connected to the end is wider than the end itself, which support part of the adjustment element bears on a side of the frame remote from the groove around the opening of the support surface situated in the frame.

The adjustment element is supported by the support surface, such that the adjustment element is incapable of performing a displacement in a direction transverse to the support surface. Thus the number of directions in which the component can be adjusted by the adjustment element can be limited to, for example, a single, desired adjustment direction in a simple manner.

A further embodiment of the system according to the invention is characterized in that the support surface is shaped as a V-groove, the walls of the support part of the adjustment element lying against the V-groove-shaped support surface.

The V-groove support surface provides a support for the adjustment element and a limitation of the displacement possibilities of the adjustment element in a simple manner.

The invention also has for its object to provide a product comprising a component that is positioned in an accurate and simple manner on a frame.

This object is achieved in the product according to the invention in that the component is provided with a groove situated opposite an opening in the frame.

Statistically, the groove will be relatively often be located asymmetrically relative to the opening in the frame because the component provided with the groove has been adjusted through the displacement of a wall of the groove and accordingly of the groove relative to the frame.

The invention will be explained in more detail below by way of example with reference to the drawings, in which:

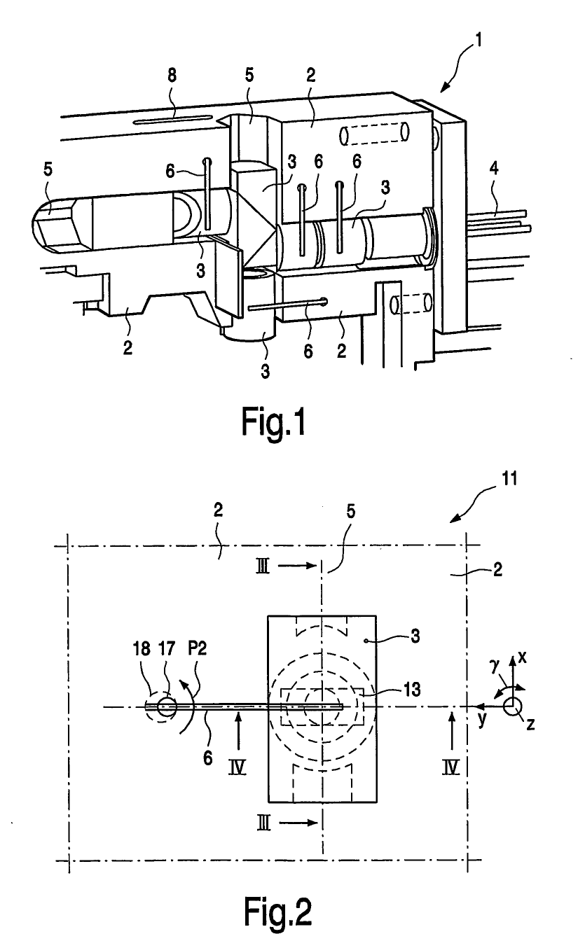

FIG. 1 is a perspective view of an embodiment of the product according to the invention,

FIG. 2 is a plan view of a system according to the invention,

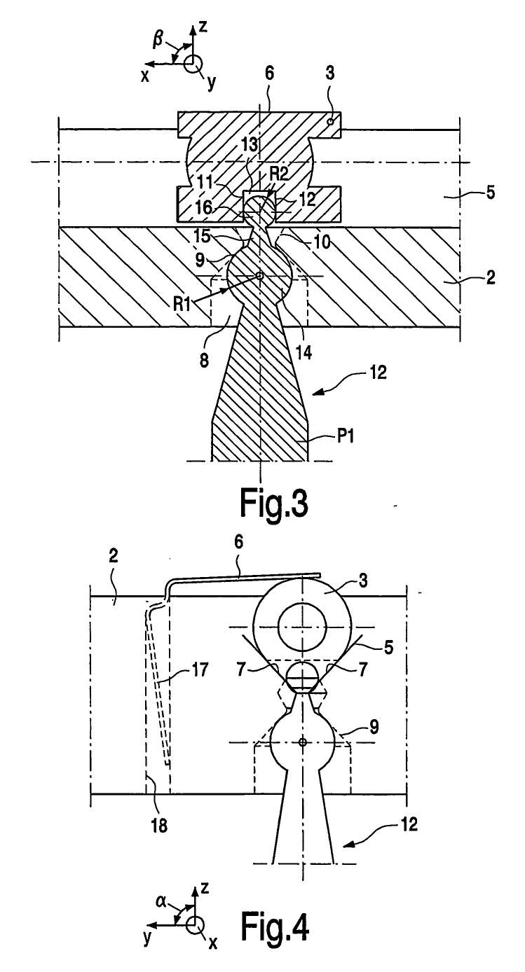

FIG. 3 is a cross-sectional view of the system of FIG. 2 taken on the line III-III, and

FIG. 4 is a cross-sectional view of the system of FIG. 2 taken on the line IV-IV.

Corresponding components have been given the same reference numerals in the Figures.

FIG. 1 is a perspective view of a product 1 according to the invention which is provided with a frame 2 in which optical components 3 are located. The optical components 3 may be, for example, lenses, collimators, deflectors, and filters. The product 1 further comprises a diagrammatically depicted laser source 4.

The optical components 3 are held in the frame in V-shaped surfaces 5. The components 3 are pressed against the surfaces 5 by a spring force of a spring 6.

An accurate alignment of the optical components 3 relative to the frame 2 is necessary if the laser beam generated by the laser source 4 is to be guided accurately through the optical components 3. To achieve this, the optical components 3 are adjusted by means of the system according to the invention as shown in FIGS. 2 to 4.

FIGS. 2 to 4 show a system 11 in plan view and in cross-sections, respectively, which system is provided next to the product 1 with an adjustment element 12 by means of which the component 3 can be adjusted in and opposed to an X-direction, as will be explained in more detail further below. As is visible in FIG. 2, the V-shaped groove 5 extends in the X-direction in the frame. The component 3 is located in the V-shaped groove 5 such that the component 3 is pressed against the V-shaped groove 5 at a side remote from the V-shaped groove 5 by a spring force of the spring 6. A displacement of the optical component 3 in and opposed to the Z-direction is not possible in this manner. The V-shape of the groove 5 in addition renders a rotation of the component 3 in and opposed to the β-direction and the γ-direction impossible as well. Furthermore, a displacement in or opposed to the Y-direction will only be possible in combination with a displacement in the Z-direction owing to the V-groove 5. As was noted above, this displacement is not possible for the component 3, which is pressed against the surface 5 by the spring 6. A displacement in or opposed to the Y-direction of the component 3 is accordingly also blocked.

To block a rotation of the component 3 about the X-axis in or opposed to the α-direction in a simple manner, the component 3 is preferably provided with mating V-shaped sides 7 (FIG. 4) corresponding to the V-shaped surface 5.

In order to displace the component 3 in or opposed to the X-direction, the frame 2 is provided with a cylindrical hole 8 which issues into a V-groove-shaped or conical support surface 9 at a side facing the component 3. This support surface 9 extends in the Y-direction. A centrally located recess 10 is provided in the V-groove-shaped support surface 9.

The component 3 is provided with a groove 13 bounded by walls 11, 12 at a side facing the frame 2 and opposite to the recess 10. The groove 13 extends parallel to the Y-direction.

The adjustment element 12 is provided with an elongate handle, a spherical segment 14 having a radius R1 connected thereto, a connecting piece 15 connected to the spherical segment 14 at the side remote from the handle, and a spherical segment 16 having a radius R2 connected to the connecting piece 15 at a side thereof remote from the spherical segment 14. The distance between the walls 11 and 12 of the groove 13 in the component is equal to or slightly greater than twice the radius R2, owing to which the spherical segment 15 can be provided in the component 3 with good fit.

The width of the recess 10 is such that both the connecting piece 15 and the spherical segment 16 connected thereto can be readily passed through this recess, whereas the larger spherical segment 14 cannot pass through the recess 10. The dimensions of the adjustment element 12 are such that, when the smaller spherical segment 16 is located in the groove 13, the larger spherical segment 14 bears on the V-groove-shaped support surface 9.

When the component 3 is to be adjusted relative to the frame 2 in or opposed to the direction indicated with X, the adjustment element 12 is pivoted in or opposed to the direction indicated by arrow P2 about the Y-axis, during which the larger spherical segment 14 rolls over the V-groove-shaped support surface 9, while the smaller spherical segment 16 connected to the spherical segment 14 is also subjected to a pivoting displacement in the direction indicated by arrow P1. Pivoting in the direction indicated by arrow P1 causes a left-hand side of the spherical segment 16 to bear on the wall 11 of the groove 13, so that the displacement of the spherical segment 16 moves the components 3 in the X-direction. Pivoting of the adjustment element 12 in the direction opposed to arrow P1 will press the right-hand side of the spherical segment against the wall 12 of the groove 13, owing to which the component 3 will be moved in the opposite X-direction. If the handle of the adjustment element 12 is comparatively long in comparison with the distance between the spherical segments 14 and 16, a comparatively major pivoting movement of the handle will result in a comparatively small displacement of the component 3 in or opposed to the X-direction. It is possible in this manner to adjust the component 3 accurately with respect to the frame 2. To check whether the component is situated in the desired position relative to the frame 2, measuring instruments known per se may be used, such as a mechanical feeler, a light beam, etc.

During the displacement of the component 3 in or opposed to the X-direction, the spring 6 remains pressed against a side of the component 3 remote from the groove 13. The spring 6 performs a pivoting displacement in or opposed to the direction indicated by arrow P2 with a pin 17 extending substantially transversely to the spring 6. As is visible in FIG. 4, the pin 17 is pivotably supported in a hole 18 extending through the frame 2. Since the spring 6 is moved along with the component 3 as it were, the spring 6 exclusively exerts a force in a direction transverse to the groove 13. It is avoided thereby that the spring 6 will exert a force on the component 3 owing to which the component 3 would be pivoted in or opposed to the β-direction.

After the component 3 has been positioned in the desired position relative to the frame 2, this position may be fixed, for example with glue. It is possible in this respect that prior to the provision of the component 3 on the frame 2 a glue, for example a UV-curing glue, is provided between the component 3 and the frame 2, which glue is cured by means of UV radiation after the component 3 has been correctly positioned with respect to the frame 2.

After the component 3 has been fixed to the frame 2, the adjustment element 12 may be removed from the groove 13 and the frame 2, whereupon the adjustment element 12 may be utilized for adjusting a next component 3.

The groove in the component may be elongate, but it is also possible to use a blind square or round hole as a groove.

The hole or groove in the frame through which the adjustment element extends may be a cylindrical hole, an elongate slot, etc.

It is obviously also possible for the frame itself to be a, for example optical, component. 3

1. A method of adjusting a component relative to a frame, characterized in that at least one adjustment element is introduced through at least one opening of the frame, such that an end of said adjustment element is positioned in a groove of the component located on the frame, and the end of the adjustment element is urged against at least a wall bounding the groove for adjusting the component into a desired position.

2. A method as claimed in claim 1, characterized in that a force is exerted on the component from a side of the component facing away from the groove, opposite the groove, whereby the component is pressed in the direction of the frame.

3. A method as claimed in claim 2, characterized in that the component is pressed against the frame by spring force.

4. A method as claimed in claim 1, characterized in that the component, once adjusted to the desired position, is fixed to the frame.

5. A method as claimed in claim 4, characterized in that the component is fixed to the frame by the application of glue.

6. A method as claimed in claim 1, characterized in that the adjustment element is removed from the frame after the component has been adjusted to the desired position.

7. A system for adjusting a component located on a frame, wherein the system comprises an adjustment element, characterized in that the adjustment element can be positioned in an opening of the frame, such that an end of the adjustment element is located in a groove of the component, and the component can be adjusted relative to the frame by means of the force exerted by the adjustment element on at least a wall bounding the groove.

8. A system as claimed in claim 7, characterized in that a support part of the adjustment element connected to the end is wider than the end itself, which support part of the adjustment element bears on a side of the frame that is remote from the groove and lies around the opening of the support surface situated in the frame.

9. A system as claimed in claim 8, characterized in that the support surface is shaped as a V-groove, the walls of the support part of the adjustment element lying against the V-groove-shaped support surface.

10. A system as claimed in claim 7, characterized in that the adjustment element is displaceable in a single degree of freedom, such that the component is adjustable by means of the adjustment element exclusively in a direction extending transversely to the groove and parallel to the frame.

11. A system as claimed in claim 7, characterized in that an element is situated opposite the side of the component remote from the groove, by means of which element the component can be pressed against the frame.

12. A system as claimed in claim 11, characterized in that said element is a spring.

13. A system as claimed in claim 12, characterized in that the spring is rotatably supported in the frame, such that an end of the spring bears on the component, which end is displaceable together with the component in the adjustment direction.

14. A system as claimed in claim 6, characterized in that the component extends in a V-groove of the frame.

15. A system as claimed in claim 6, characterized in that the component is an optical component.

16. A product manufactured by the method as claimed in claim 1, which product comprises an adjusted component located on a frame, characterized in that the component is provided with a groove situated opposite an opening of the frame.

17. A product as claimed in claim 16, characterized in that the adjusted component is fixed to the frame.
